(19) United States
(12) Patent Application Publication
(10) Pub. No.: US 2024/0134371 A1
(43) Pub. Date: Apr. 25, 2024

(54) Dynamic Operational Adjustment of Mobile Worker Edge Devices by a Mobile Controller Edge Device

(71) Applicant: International Business Machines Corporation, Armonk, NY (US)

(72) Inventors: Jenny S. Li, Franklinton, NC (US); Satish Rajani, Dewas (IN); Raghu Ramaswamy, Bengaluru (IN); Gopalan Shankar, Boca Raton, FL (US)

(21) Appl. No.: 18/048,115

(22) Filed: Oct. 19, 2022

(51) Int. Cl. G05D 1/00; G05D 1/02

(52) U.S. Cl. CPC G05D 1/0027; G05D 1/0212

(57) ABSTRACT

Adjusting a navigation path of a worker land roaming edge device is provided. The worker land roaming edge device is identified moving along a navigation path to an asset to perform a task. It is determined that the worker land roaming edge device cannot reach the asset to perform the task due to an environment change along the navigation path. A set of task performance alternatives is generated in response to determining that the worker land roaming edge device cannot reach the asset to perform the task. A task performance alternative of the set of task performance alternatives is selected based on a set of criteria. The navigation path of the worker land roaming edge device is adjusted in accordance with the selected task performance alternative. The adjusted navigation path is sent to the worker land roaming edge device to dynamically adjust operation of the worker land roaming edge device.

### BACKGROUND

### 1. Field

The disclosure relates generally to mobile edge computing and more specifically to performing dynamic operational adjustment of mobile worker edge devices by a mobile controller edge device.

### 2. Description of the Related Art

Edge computing is a distributed computing paradigm that brings computation closer to data sources (i.e., where the data is generated by edge devices). This enables rapid, real time data analysis and response. Mobile edge computing is the outermost edge where mobile edge devices generate large amounts of data while performing tasks. Mobile edge computing is the relationship between edge computing and mobility of devices, such as, for example, mobile video cameras, mobile gaming devices, mobile vehicles, or any other type of mobile Internet of Things device. For example, a mobile edge computer can increase mobile edge device performance and reduce latency by bringing compute and other resources as physically close to where they're needed as possible.

### SUMMARY

According to one illustrative embodiment, a computer-implemented method for adjusting a navigation path of a worker land roaming edge device is provided. A controller flying roaming edge device identifies the worker land roaming edge device moving along a navigation path to an asset to perform a task. The controller flying roaming edge device determines that the worker land roaming edge device cannot reach the asset to perform the task due to an environment change along the navigation path. The controller flying roaming edge device generates a set of task performance alternatives in response to determining that the worker land roaming edge device cannot reach the asset to perform the task. The controller flying roaming edge device selects a task performance alternative of the set of task performance alternatives based on a set of criteria to form a selected task performance alternative. The controller flying roaming edge device adjusts the navigation path of the worker land roaming edge device in accordance with the selected task performance alternative to form an adjusted navigation path. The controller flying roaming edge device sends the adjusted navigation path to the worker land roaming edge device to dynamically adjust operation of the worker land roaming edge device. According to other illustrative embodiments, a controller flying roaming edge device and computer program product for adjusting a navigation path of a worker edge land roaming edge device are provided.

### BRIEF DESCRIPTION OF THE DRAWINGS

FIG. 1 is a pictorial representation of a computing environment in which illustrative embodiments may be implemented;

FIG. 2 is a diagram illustrating an example of a worker edge device management system in accordance with an illustrative embodiment;

FIGS. 3A-3D are a flowchart illustrating a process for managing task performance by worker edge devices in accordance with an illustrative embodiment; and

FIG. 4 is a flowchart illustrating a process for adjusting a navigation path of a worker edge device in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

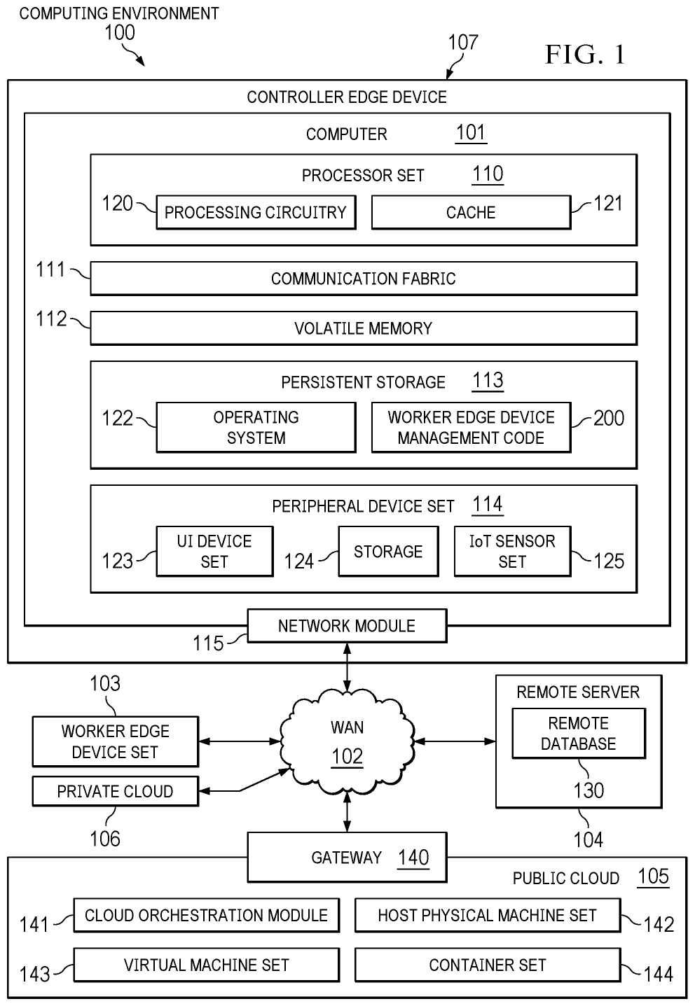

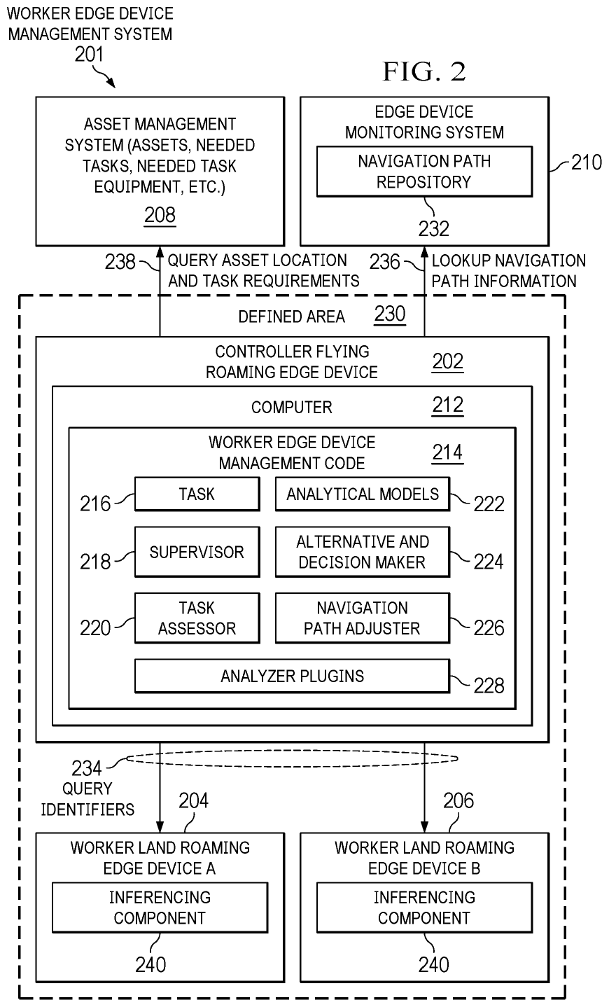

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as worker edge device management code 200. In addition to worker edge device management code block 200, computing environment 100 includes, for example, computer 101, wide area network (WAN) 102, worker edge device set 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and worker edge device management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 is located in controller edge device 107. Controller edge device 107 may take any form of flying roaming edge device that can, for example, fly, hover, or the like in the air above the ground at any altitude over a defined area. Controller edge device 107 manages task performance of worker edge device set 103, which operates in the defined area, using worker edge device management code 200. Worker edge device set 103 represents one or more worker land roaming edge devices under operational control by controller edge device 107.

Computer 101 may take the form of any type of mobile computing or data processing device now known or to be developed in the future that is capable of running a program, accessing a network, and querying a database, such as remote database 130. Computer 101 provides the data processing and analysis capabilities of controller edge device 107.

As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 can be coupled to a cloud environment. On the other hand, computer 101 is not required to be coupled to a cloud environment except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in worker edge device management code block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The worker edge device management code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, touchpad, and the like. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

Worker edge device set 103 may take any form of worker land roaming edge devices that can, for example, wheel, tread, roll, crawl, squirm, slither, hop, or the like over terrain to a specified location (e.g., a way point) along a defined navigation path to perform a set of assigned tasks, functions, actions, jobs, duties, or the like. Worker edge device set 103 receives relevant data from the operations of computer 101. For example, computer 101 is designed to provide navigation path adjustments to worker edge device set 103 when worker edge device management code 200 detects unexpected obstructions or obstacles in the navigation paths of worker edge device set 103. Computer 101 utilizes network module 115 to communicate the navigation path adjustments to worker edge device set 103 via WAN 102.

Remote server 104 is any computer system that serves at least some data and/or functionality to computer 101 and can represent a set of remote servers. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Mobile edge devices come in many different forms and these mobile edge devices can operate, for example, on the ground, in the air, or in the water on the edge of a network. A mobile edge device has a predefined navigation path that the mobile edge device can travel along. A land roaming edge device, which operates on the ground, is preprogrammed to undertake a set of tasks, such as, for example, inspection of physical assets in an electrical substation. The preprogrammed set of tasks of the land roaming edge device may fail due to dynamic changes in conditions of the environment surrounding or along the predefined navigation path. For example, the predefined navigation path may direct the land roaming edge device to enter a specified location within a defined area (e.g., building, hallway, stairway, room, aisle, yard, field, parking lot, or the like) to perform an assigned task. The land roaming edge device expects a clear navigation path (e.g., free from obstacles or obstructions) to the specified location. However, while traversing the predefined navigation path, the land roaming edge device can encounter an unexpected obstruction due to dynamic changes in the environment in or around the predefined navigation path. As a result, this unexpected obstruction can cause task performance failure by the land roaming edge device because the land roaming edge device cannot reach to specified location to perform the assigned task using the predefined navigation path.

Similarly, a flying roaming edge device can also perform assigned tasks, such as inspecting physical assets on the ground. The flying roaming edge device has an increased overhead field of view of the assets and any ground obstruction will not impair the flying roaming edge device from performing its assigned tasks. However, the flying roaming edge device is limited as to amount of payload. As a result, the flying roaming edge device may not be capable of carrying certain additional sensors, such as, for example, imaging sensors, infrared sensors, vibration sensors, acoustic sensors, temperature sensors, and the like, which the flying roaming edge device may need to perform different types of tasks. Thus, task completion by the flying roaming edge device is impacted because the flying roaming edge device does not have the same payload flexibility and capabilities as land roaming edge devices.

Illustrative embodiments take into account and address the constraints of these different mobile edge devices and their static predefined navigation paths. Illustrative embodiments overcome these constraints by utilizing a controller flying roaming edge device to dynamically adjust or modify the predefined navigation paths of worker land roaming edge devices performing tasks based on unexpected real time changes in the environment surrounding the worker land roaming edge devices.

It should be noted that illustrative embodiments do not utilize collaborative mobile edge devices. Collaborative mobile edge devices are a plurality of mobile edge devices that are collectively preassigned to perform a single task, such as, for example, harvest grain in a field. This is a divide and conquer approach where each respective mobile edge device of the plurality of mobile edge devices performs only a subtask (i.e., a portion or segment) of the entire task preassigned to the plurality of mobile edge devices, and by combining all of the subtasks performed each respective mobile edge device, the entire task is completed. Instead, illustrative embodiments utilize two different types of mobile edge devices (i.e., a controller flying roaming edge device and worker land roaming edge devices). Illustrative embodiments equip the controller flying roaming edge device with intelligence to detect environment changes in real time along navigation paths of worker land roaming edge devices and to dynamically adjust the navigation path of one or more worker land roaming edge devices operating in the area assigned to the controller flying roaming edge device based on the detected environment changes.

Illustrative embodiments utilize the controller flying roaming edge device to oversee the operations of a set of worker ground roaming device devices, each respective worker land roaming edge device having its own predefined navigation path for performance of its own set of different tasks. The controller flying roaming edge device serves as a supervisor of the set of worker ground roaming device devices operating in the area assigned to the controller flying roaming edge device. While each respective worker ground roaming device is loaded with its own predefined navigation path to perform its set of assigned tasks, real time environment changes or circumstances (e.g., an unexpected obstruction or people in the area) may occur that prevent a particular worker land roaming edge device from progressing forward on its predefined navigation path. The controller flying roaming edge device has the intelligence to recognize that that particular worker land roaming edge device is stopped and needs task performance assistance. In response to the controller flying roaming edge device recognizing that the worker land roaming edge device is stopped, the controller flying roaming edge device determines a set of task performance alternatives, such as, for example, adjusting the predefined navigation path of that particular that the worker land roaming edge device to reroute the worker land roaming edge device around the obstruction or people to perform the task, instructing another worker land roaming edge device in the set of worker land roaming edge devices to perform that particular task instead of the original worker land roaming edge device, or the like.

As an illustrative scenario, the controller flying roaming edge device monitors for any obstruction, obstacle, foreign object, mobile machine, or the like that has unexpectedly appeared in the predefined navigation path of a worker land roaming edge device in the defined area monitored by the controller flying roaming edge device. For example, worker land roaming edge device “A” is following its predefined navigation path in a steel mill to perform an assigned task of inspecting a blast furnace. An obstruction, such as, for example, an overhead crane moving an iron ore bucket, is in the predefined navigation path of worker land roaming edge device A. Worker land roaming edge device A would not be aware of such an obstruction ahead of time. The controller flying roaming edge device is monitoring the area along the predefined navigation path of worker land roaming edge device A. The controller flying roaming edge device predicts that worker land roaming edge device A will reach the obstruction in 1 minute. In this illustrative scenario, the controller flying roaming edge device identifies an alternative navigation path for worker land roaming edge device A to perform the inspection task, if possible, or assigns worker land roaming edge device “B” to perform the inspection task as the controller flying roaming edge device has determined that worker land roaming edge device B is already in close proximity to the blast furnace and has the needed equipment to perform the inspection.

As another illustrative scenario, the controller flying roaming edge device monitors for any dynamic environment changes in the defined area monitored by the controller flying roaming edge device. For example, a group of people (e.g., human workers) enter the same area as the set of worker land roaming edge devices. It is not safe for the set of worker land roaming edge devices to operate in a crowded environment. The controller flying roaming edge device recognizes the group of people just entering the environment (i.e., the crowdedness of the environment) in real time. The controller flying roaming edge device adjusts the navigation paths of the set of worker land roaming edge devices by instructing the set of worker land roaming edge devices to immediately stop moving or to go to a designated resting location until the group of people has left the area.

As a further illustrative scenario, the controller flying roaming edge device monitors for proximity of worker land roaming edge devices in the defined area monitored by the controller flying roaming edge device. For example, worker land roaming edge device C is reading analog gauges of a water pump in a particular aisle of the steel mill. Worker land roaming edge device D enters that same aisle to inspect a fire extinguisher. The controller flying roaming edge device determines that worker land roaming edge device C and worker land roaming edge device D are in close physical proximity to each other in that aisle and that worker land roaming edge device D will have a narrow space to pass by worker land roaming edge device C to proceed on to worker land roaming edge device D's next inspection task. As a result, the controller flying roaming edge device determines that a potential collision may occur between worker land roaming edge device C and worker land roaming edge device D in that aisle. Consequently, the controller flying roaming edge device adjusts the navigation path of worker land roaming edge device D so that worker land roaming edge device D will stop proceeding to its next inspection location until worker land roaming edge device C has finished its water pump gauge readings and left that aisle.

As a further illustrative scenario, the controller flying roaming edge device requests performance of the same or a similar task by a worker land roaming edge device in the defined area monitored by the controller flying roaming edge device. For example, the controller flying roaming edge device performs its own assigned task of an overhead thermal inspection of an electric substation corresponding to the steel mill. The controller flying roaming edge device detects that the overhead temperature of a distribution transformer of the electric substation is above a defined maximum threshold temperature level. As a result, the controller flying roaming edge device dynamically generates a navigation path for a worker land roaming edge device in the area that is equipped with a specific sensor and gauge reader to perform a second thermal inspection of the distribution transformer. The controller flying roaming edge device loads the dynamically generated navigation path to that particular worker land roaming edge device equipped with the specific sensor and gauge reader. Afterward, that particular worker land roaming edge device performs the second thermal inspection. In addition, that particular worker land roaming edge device, using an inferencing component, generates a set of inferences based on a result of the second thermal inspection. The worker land roaming edge device then sends the set of inferences to the controller flying roaming edge device. The controller flying roaming edge device performs an analysis of the set of inferences. Then, the controller flying roaming edge device performs one or more action steps, such as, for example, generate a work request, schedule subsequent inspections at defined time intervals, and the like, based on the result of the analysis.

Thus, illustrative embodiments enable safe completion of assigned tasks by worker land roaming edge devices. A user, such as, for example, a system administrator, initially predefines the navigation path of each respective worker land roaming edge device. A navigation path is a defined route that consists of a set of way points for a worker land roaming edge device to perform a set of assigned tasks at each respective way point of the defined route. It should be noted that the set of assigned tasks may be the same or different at each respective way point. The controller flying roaming edge device initially uploads the predefined navigation path to a corresponding worker land roaming edge device. Triggering of a worker land roaming edge device to perform its assigned set of tasks can be done manually by the user or automatically via a centralized asset management system. For example, illustrative embodiments can trigger a worker land roaming edge device to perform its set of assigned tasks corresponding to a set of specified ground assets of an entity (e.g., an enterprise, company, business, organization, institution, agency, or the like) via the centralized asset management system.

The user also predefines the geographic boundaries of the area or zone that the controller flying roaming edge device is to operate within and manage. Unlike a worker land roaming edge device, the controller flying roaming edge device monitors and controls the worker land roaming edge devices operating within the predefined area of the controller flying roaming edge device. In addition, the controller flying roaming edge device may also perform a set of its own assigned tasks.

The controller flying roaming edge device identifies the navigation path and the set of tasks corresponding to each respective worker land roaming edge device operating in the area monitored by the controller flying roaming edge device and determines whether a particular worker land roaming edge device can complete the set of tasks assigned to that particular worker land roaming edge device. For example, the controller flying roaming edge device, using one or more analytical models, detects that a particular worker land roaming edge device is operating within the area monitored by the controller flying roaming edge device. The controller flying roaming edge device queries the detected worker land roaming edge device for an identifier corresponding to that particular worker land roaming edge device.

In response to receiving the query, that particular worker land roaming edge device sends its identifier to the controller flying roaming edge device. The controller flying roaming edge device then wirelessly connects to a centralized edge device monitoring system, which includes a repository of navigation paths and assigned tasks for each respective worker land roaming edge device, to look up the navigation path and set of assigned tasks corresponding to that particular worker land roaming edge device at way points along the navigation path. Based on locating the navigation path and set of assigned tasks corresponding to that particular worker land roaming edge device in the centralized edge device monitoring system, the controller flying roaming edge device determines that the worker land roaming edge device is navigating to a particular way point along the navigation path to perform a particular task (e.g., inspection of a particular boiler asset) in its set of assigned task.

The controller flying roaming edge device flies overhead along the navigation path to the boiler asset. The controller flying roaming edge device inspects the navigation path to the boiler asset and area surrounding the boiler asset. In this example, the controller flying roaming edge device, utilizing computer vision for example, identifies an obstacle (e.g., a forklift) along the navigation path of the worker land roaming edge device to the boiler asset. In response to identifying the obstacle, the controller flying roaming edge device raises an alert that an obstacle is along the navigation path of the worker land roaming edge device to the boiler asset and determines that the worker land roaming edge device cannot currently perform the boiler asset inspection task due to the identified obstacle.

In response to determining that the worker land roaming edge device cannot currently perform the boiler asset inspection task, the controller flying roaming edge device determines a set of task performance alternatives. For example, the controller flying roaming edge device queries the asset management system to identify the equipment (e.g., particular set of sensors) needed by a worker land roaming edge device to perform the boiler asset inspection task. In this example, the needed equipment is a pan, tilt, and zoom (PTZ) video camera, which allows the user to control the camera remotely, and an infrared camera. As a first alternative, the controller flying roaming edge device identifies an alternate navigation path for the worker land roaming edge device to arrive at the boiler asset to perform the inspection task. However, the controller flying roaming edge device determines that it will take the worker land roaming edge device 15 minutes to arrive at the boiler asset using the alternate navigation path. As a second alternative, the controller flying roaming edge device identifies a second worker land roaming edge device (e.g., via edge device detection and identifier query) in closer proximity to the boiler asset as compared to the first worker land roaming edge device, which is 15 minutes away from the boiler asset using the alternative navigation path. The controller flying roaming edge device has identified that the second worker land roaming edge device has the needed equipment (e.g., PTZ camera and infrared camera) to perform the inspection task and that the second worker land roaming edge device can arrive at the boiler asset in 3 minutes.

In response to determining the set of alternatives, the controller flying roaming edge device selects a best alternative from the set of alternatives based on a set of decision-making criteria. The set of decision-making criteria includes, for example, select the worker land roaming edge device having the shortest travel time to the asset to perform the task, utilize the alternative that effects the least number of worker land roaming edge devices in the predefined area, stop all worker land roaming edge devices within the predefined area when more than a threshold number of people are present in the predefined area, stop the worker land roaming edge device when environmental conditions (e.g., heavy rains, electrical storm, or the like) are not conducive to task performance by the worker land roaming edge device, et cetera. The set of decision-making criteria may be in priority order. For example, selecting the worker land roaming edge device having the shortest travel time to the asset to perform the task can have the highest priority. In this example, the controller flying roaming edge device determines that utilizing the second worker land roaming edge device, which can arrive at the boiler asset in 3 minutes as opposed to the first worker land roaming edge device that can arrive at the boiler asst in 15 minutes using the alternate navigation path, to perform the boiler asset inspection is the best alternative.

In response to selecting the best alternative for the example above, the controller flying roaming edge device dynamically adjusts the navigation path and set of assigned tasks of both worker land roaming edge devices. For example, the controller flying roaming edge device adjusts the navigation path and set of assigned tasks corresponding to the first worker land roaming edge device such that the first worker land roaming edge device no longer needs to navigate to and inspect the boiler asset. For example, the controller flying roaming edge device will override the first worker land roaming edge device's current set of tasks by removing the boiler asset inspection task (i.e., that particular way point) from the navigation path of the first worker land roaming edge device. In addition, the controller flying roaming edge device also updates the centralized edge device monitoring system regarding the adjustment to the navigation path of the first worker land roaming edge device.

The controller flying roaming edge device also adjusts the navigation path and set of assigned tasks corresponding to the second worker land roaming edge device by adding the boiler asset inspection task and the navigation path to the boiler asset to the second worker land roaming edge device in order for the second worker land roaming edge device to navigate to the boiler asset from its current location and perform the inspection task. For example, the controller flying roaming edge device inserts a new way point in the navigation path of the second worker land roaming edge device so that the second worker land roaming edge device will now also perform the inspection of the boiler asset after the second worker land roaming edge device finishes its current task.

In response to receiving the new way point in its navigation path to perform the boiler asset inspection task from the controller flying roaming edge device and completing its current task, the second worker land roaming edge device proceeds to the new way point inserted in its navigation path to perform the boiler asset inspection. Moreover, because the controller flying roaming edge device deleted the way point from the first worker land roaming edge device's navigation path and no longer needs to perform the boiler asset inspection, the first worker land roaming edge device will then move to its next way point in its navigation path to perform its next task in its own set of assigned tasks.

Thus, illustrative embodiments provide one or more technical solutions that overcome a technical problem with unexpected obstructions, obstacles, environmental changes, or the like occurring in predefined navigation paths of mobile edge devices preventing task performance. As a result, these one or more technical solutions provide a technical effect and practical application in the field of mobile edge devices.

With reference now to FIG. 2, a diagram illustrating an example of a worker edge device management system is depicted in accordance with an illustrative embodiment. Worker edge device management system 201 may be implemented in a computing environment, such as computing environment 100 in FIG. 1. Worker edge device management system 201 is a system of hardware and software components for performing dynamic operational adjustments to mobile worker edge devices by a mobile controller edge device.

In this example, worker edge device management system 201 includes controller flying roaming edge device 202, worker land roaming edge device A 204, worker land roaming edge device B 206, asset management system 208, and edge device monitoring system 210. However, it should be noted that worker edge device management system 201 is intended to be an example only and not as a limitation on illustrative embodiments. For example, worker edge device management system 201 can include any number of controller flying roaming edge devices, worker land roaming edge devices, asset management systems, edge device monitoring systems, and other devices and components not shown.

Controller flying roaming edge device 202 may be, for example, controller edge device 107 in FIG. 1. Controller flying roaming edge device 202 includes computer 212, such as, for example, computer 101 in FIG. 1. Computer 212 includes worker edge device management code 214, such as, for example, worker edge device management code 200 in FIG. 1.

In this example, worker edge device management code 214 is comprised of task 216, supervisor 218, task assessor 220, analytic models 222, alternative and decision maker 224, navigation path adjuster 226, and analyzer plugins 228. However, it should be noted that worker edge device management code 214 is intended as an example only and not as a limitation on illustrative embodiments. In other words, worker edge device management code 214 can include more or fewer components than shown. For example, a component may be divided into two or more components, two or more components may be combined into one component, components not shown (e.g., security plugins, storage, business rules and policies, and the like) may be added, a component may be removed, or the like.

Task 216 defines the area (i.e., defined area 230) that controller flying roaming edge device 202 is responsible for monitoring. Defined area 230 may represent any type of area, zone, region, district, locale, vicinity, or the like that has specific boundaries within which a set of mobile edge devices (i.e., worker land roaming edge device A 204 and worker land roaming edge device B 206) operate to perform assigned tasks on different assets. Worker land roaming edge device A 204 and worker land roaming edge device B 206 may be, for example, worker edge device set 103 in FIG. 1. The assets may be any type of physical ground asset, such as, for example, machines, vehicles, equipment, gauges, storage units, crops, vegetation, soil, animals, or the like.

Supervisor 218 detects, monitors, and records worker land roaming edge device A 204 and worker land roaming edge device B 206 operating within defined area 230 monitored by controller flying roaming edge device 202. For example, supervisor 218 monitors and records performance of assigned tasks corresponding to worker land roaming edge device A 204 and worker land roaming edge device B 206 that controller flying roaming edge device 202 has observed so far. Further, supervisor 218 also records any adjustments to the navigation path of worker land roaming edge device A 204 or worker land roaming edge device B 206 that controller flying roaming edge device 202 may have made due to, for example, detection of an unexpected obstruction in a particular navigation path.

Task assessor 220 determines whether worker land roaming edge device A 204 or worker land roaming edge device B 206 operating within defined area 230 monitored by controller flying roaming edge device 202 can complete a particular assigned task (e.g., an asset inspection) using its current navigation path or whether worker land roaming edge device A 204 or worker land roaming edge device B 206 has that needed equipment to perform that particular task. In addition, task assessor 220 confirms the safety of each respective worker land roaming edge device and any humans in defined area 230.

Analytic models 222 may include, for example, machine learning models, which can include computer vision and the like. Controller flying roaming edge device 202 utilizes analytic models 222 to recognize objects (e.g., worker land roaming edge devices, assets, humans, and the like) within defined area 230. Controller flying roaming edge device 202 can also utilize analytic models 222 to perform overhead inspections of assets in the field of view of controller flying roaming edge device 202.

Alternative and decision maker 224 determines a set of task performance alternatives for a particular worker land roaming edge device or a set of other worker land roaming edge devices to complete a particular task in response to task assessor 220 determining that that particular worker land roaming edge device cannot complete that particular task using the current navigation path of that particular worker land roaming edge device. Alternative and decision maker 224 selects the most appropriate task performance alternative based on the set of decision-making criteria, which can include predefined rules or guiding principles of the entity, such as an enterprise or business, owning or managing the assets.

Navigation path adjuster 226 automatically adjusts or modifies the navigation path of a particular worker land roaming edge device or a set of worker land roaming edge devices based on the task performance alternative selected by alternative and decision maker 224. Controller flying roaming edge device 202 downloads the adjusted navigation path to that particular worker land roaming edge device or the set of worker land roaming edge devices and sends the adjusted navigation path, along with all real time worker land roaming edge device monitoring information, to edge device monitoring system 210.

Analyzer plugins 228 call and connect to external systems and services, such as, for example, weather information services, navigation information services, environment information services (e.g., crowdedness information corresponding to defined area 230, information regarding confined spaces in defined area 230, information regarding accidents in defined area 230, information regarding spillage in defined area 230, information regarding tough terrain in defined area 230, and the like), and any other type of information service. Task assessor 220 can utilize each of analyzer plugins 228 to obtain relevant information that will assist task assessor 220 in determining whether a particular worker land roaming edge device can complete a particular task.

Asset management system 208 maintains asset details regarding each particular asset within defined area 230. Asset management system 208 may be, for example, remote server 104 in FIG. 1. Asset details can include, for example, identification information (e.g., identifier, asset name, asset type, asset geographic location such as GPS coordinates, and the like) corresponding to each respective asset corresponding to the entity. Asset details can also include asset maintenance information, such as, for example, tasks needed (e.g., inspections), time intervals between task performance, equipment needed for task performance, and the like.

Edge device monitoring system 210 is a centralized monitoring system that maintains the current status of each respective worker land roaming edge device including, for example, current navigation path status (e.g., current way point of a particular worker land roaming edge device), set of assigned tasks, current task performance, battery life, current geographic location, onboard equipment (e.g., types of sensors), sensor data, and the like. Edge device monitoring system 210 may be, for example, another remote server 104 in FIG. 1. Edge device monitoring system 210 also includes navigation path repository 232, which stores the navigation paths of all of the worker land roaming edge devices operating in defined area 230. Navigation path repository 232 may be, for example, remote database 130 in FIG. 1.

Controller flying roaming edge device 202 begins flying over defined area 230 to start its monitoring task of any worker land roaming edge devices operating in defined area 230. At 234, controller flying roaming edge device 202 detects worker land roaming edge device A 204 and worker land roaming edge device B 206 in defined area 230 and queries worker land roaming edge device A 204 and worker land roaming edge device B 206 for their corresponding identifiers. At 236, controller flying roaming edge device 202 wirelessly connects to edge device monitoring system 210 to lookup navigation path information corresponding to worker land roaming edge device A 204 and worker land roaming edge device B 206, which is contained in navigation path repository 232, based on their respective identifiers. In addition, at 238, controller flying roaming edge device 202 wirelessly connects to asset management system 208 to query asset location and requirements of respective tasks to be performed on different assets by worker land roaming edge device A 204 and worker land roaming edge device B 206.

Subsequently, worker land roaming edge device A 204 and worker land roaming edge device B 206 complete their respective tasks on the different assets. It should be noted that worker land roaming edge device A 204 and worker land roaming edge device B 206 both include inferencing component 240. Inferencing component 240 provides an inferenced or deduced result of performance of a particular task (e.g., an inspection) corresponding to a particular asset based on data collected by, for example, a set of sensors located on worker land roaming edge device A 204 and worker land roaming edge device B 206. However, in an alternative illustrative embodiment, the inferencing component may be included in a remote server instead of being located locally on each individual worker land roaming edge device.

Afterward, worker land roaming edge device A 204 and worker land roaming edge device B 206 send the results of inferencing component 240 to controller flying roaming edge device 202 for analysis. Based on the analysis of the results of inferencing component 240, controller flying roaming edge device 202 performs a set of action steps, such as, for example, send an alert to a system administrator regarding impaired operation of an asset, generate a work request to repair the asset, request further inspections of the asset, and the like.

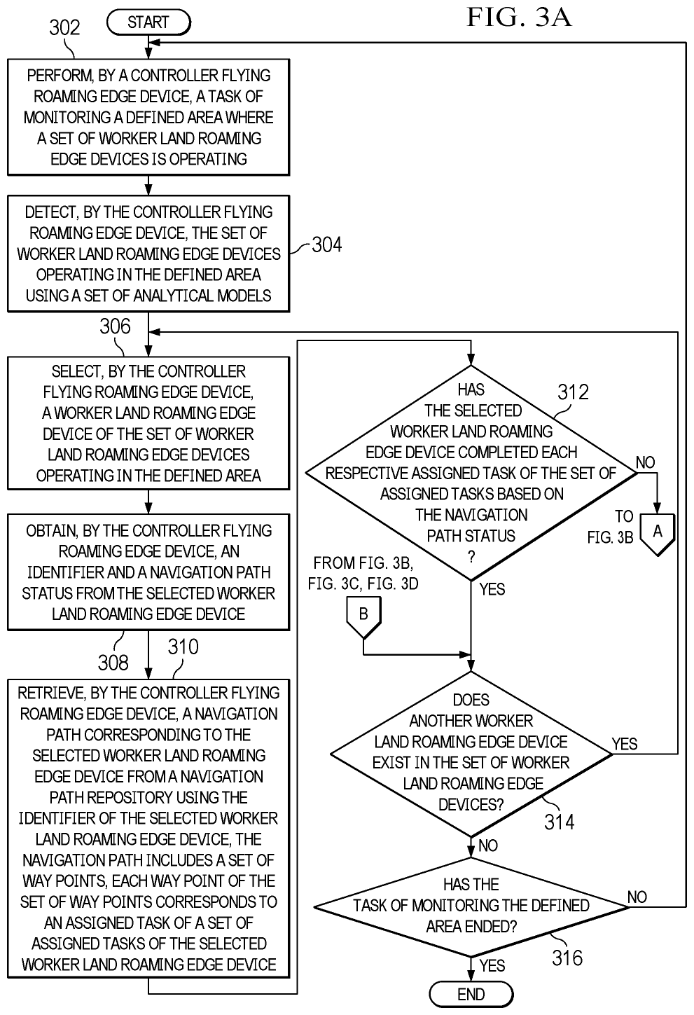

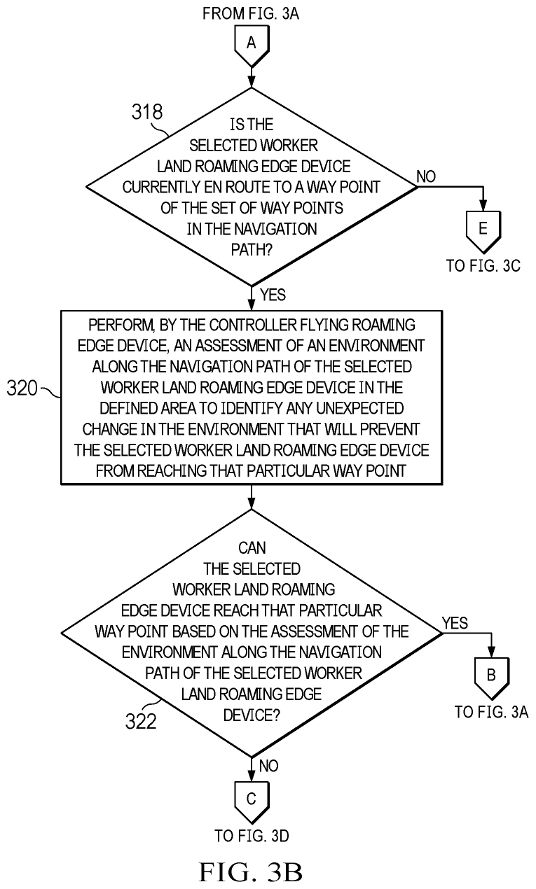

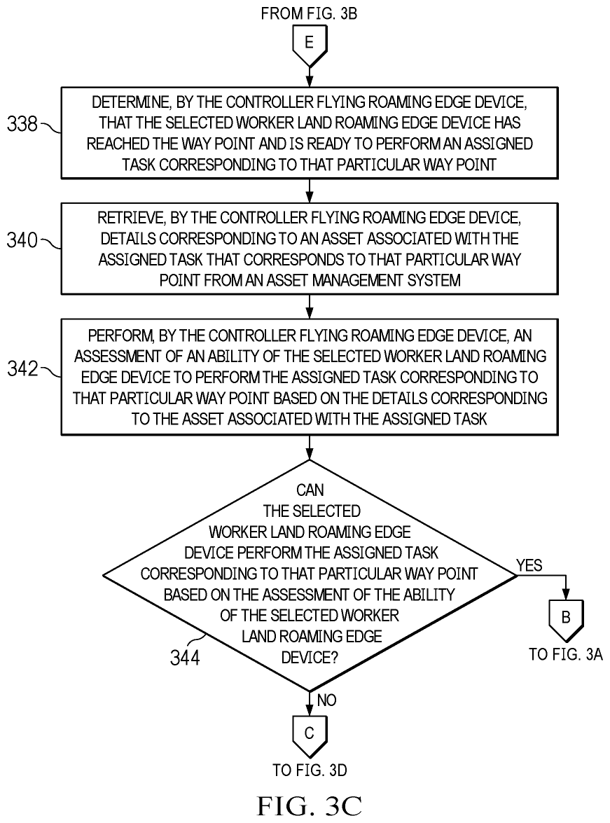

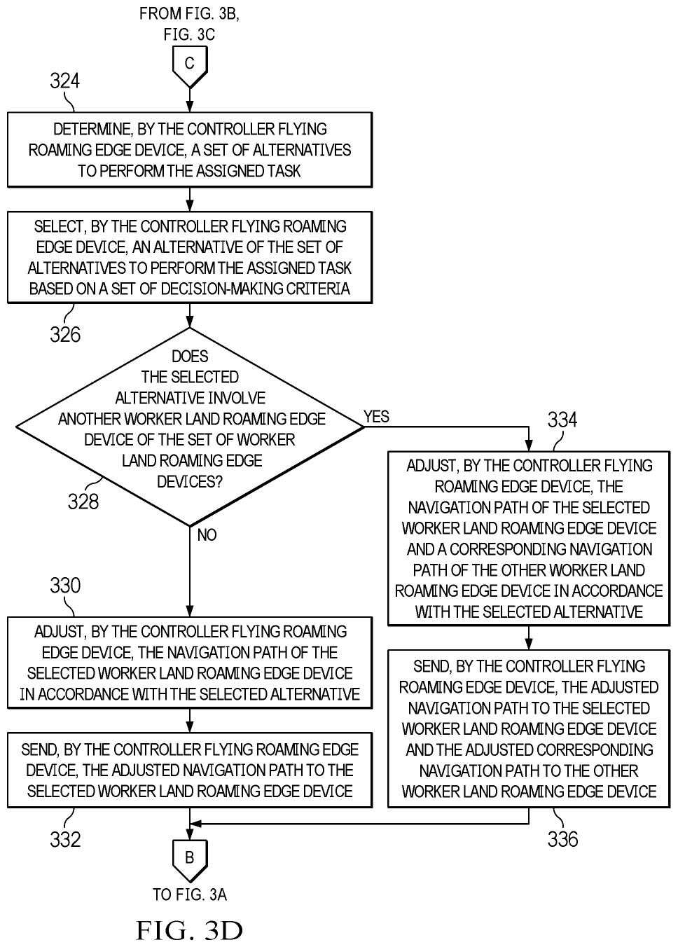

With reference now to FIGS. 3A-3D, a flowchart illustrating a process for managing task performance by worker edge devices is shown in accordance with an illustrative embodiment. The process shown in FIGS. 3A-3D may be implemented in a controller edge device, such as, for example, controller edge device 107 in FIG. 1 or controller flying roaming edge device 202 in FIG. 2. For example, the process shown in FIGS. 3A-3D may be implemented in worker edge device management code 200 in FIG. 1 or worker edge device management code 214 in FIG. 2.

The process begins when the controller flying roaming edge device performs a task of monitoring a defined area where a set of worker land roaming edge devices is operating (step 302). Subsequently, the controller flying roaming edge device detects the set of worker land roaming edge devices operating in the defined area using a set of analytical models (step 304). The controller flying roaming edge device selects a worker land roaming edge device of the set of worker land roaming edge devices operating in the defined area to form a selected worker land roaming edge device (step 306).

The controller flying roaming edge device obtains an identifier and a navigation path status from the selected worker land roaming edge device (step 308). The controller flying roaming edge device retrieves a navigation path corresponding to the selected worker land roaming edge device from a navigation path repository using the identifier of the selected worker land roaming edge device (step 310). The navigation path includes a set way points. Each way point of the set of way points corresponds to an assigned task of a set of assigned tasks of the selected worker land roaming edge device.

The controller flying roaming edge device makes a determination as to whether the selected worker land roaming edge device has completed each respective assigned task of the set of assigned tasks based on the navigation path status (step 312). If the controller flying roaming edge device determines that the selected worker land roaming edge device has completed each respective assigned task of the set of assigned tasks based on the navigation path status, yes output of step 312, then the controller flying roaming edge device makes a determination as to whether another worker land roaming edge device exists in the set of worker land roaming edge devices (step 314). If the controller flying roaming edge device determines that another worker land roaming edge device does exist in the set of worker land roaming edge devices, yes output of step 314, then the process returns to step 306 where the controller flying roaming edge device selects another worker land roaming edge device from the set of worker land roaming edge devices. If the controller flying roaming edge device determines that another worker land roaming edge device does not exist in the set of worker land roaming edge devices, no output of step 314, then the controller flying roaming edge device makes a determination as to whether the task of monitoring the defined area has ended (step 316). If the controller flying roaming edge device determines that the task of monitoring the defined area has not ended, no output of step 316, then the process returns to step 302 where the controller flying roaming edge device continues to monitor the defined area. If the controller flying roaming edge device determines that the task of monitoring the defined area has ended, yes output of step 316, then the process terminates thereafter.

Returning again to step 312, if the controller flying roaming edge device determines that the selected worker land roaming edge device has not completed each respective assigned task of the set of assigned tasks based on the navigation path status, no output of step 312, then the controller flying roaming edge device makes a determination as to whether the selected worker land roaming edge device is currently en route to a way point of the set of way points in the navigation path (step 318). If the controller flying roaming edge device determines that the selected worker land roaming edge device is currently en route to a way point of the set of way points in the navigation path, yes output of step 318, then the controller flying roaming edge device performs an assessment of an environment along the navigation path of the selected worker land roaming edge device in the defined area to identify any unexpected change in the environment that will prevent the selected worker land roaming edge device from reaching that particular way point (step 320).

Afterward, the controller flying roaming edge device makes a determination as to whether the selected worker land roaming edge device can reach that particular way point based on the assessment of the environment along the navigation path of the selected worker land roaming edge device (step 322). If the controller flying roaming edge device determines that the selected worker land roaming edge device can reach that particular way point based on the assessment of the environment along the navigation path of the selected worker land roaming edge device, yes output of step 322, then the process returns to step 314 where the controller flying roaming edge device determines whether another worker land roaming edge device exists in the set of worker land roaming edge devices. If the controller flying roaming edge device determines that the selected worker land roaming edge device cannot reach that particular way point based on the assessment of the environment along the navigation path of the selected worker land roaming edge device, no output of step 322, then the controller flying roaming edge device determines a set of alternatives to perform the assigned task (step 324).

The controller flying roaming edge device selects an alternative of the set of alternatives to perform the assigned task based on a set of decision-making criteria (step 326). The controller flying roaming edge device makes a determination as to whether the selected alternative involves another worker land roaming edge device of the set of worker land roaming edge devices (step 328). If the controller flying roaming edge device determines that the selected alternative does not involve another worker land roaming edge device of the set of worker land roaming edge devices, no output of step 328, then the controller flying roaming edge device adjusts the navigation path of the selected worker land roaming edge device in accordance with the selected alternative to form an adjusted navigation path (step 330). The controller flying roaming edge device sends the adjusted navigation path to the selected worker land roaming edge device (step 332). Thereafter, the process returns to step 314 where the controller flying roaming edge device determines whether another worker land roaming edge device exists in the set of worker land roaming edge devices.

Returning again to step 328, if the controller flying roaming edge device determines that the selected alternative does involve another worker land roaming edge device of the set of worker land roaming edge devices, yes output of step 328, then the controller flying roaming edge device adjusts the navigation path of the selected worker land roaming edge device and adjusts a corresponding navigation path of the other worker land roaming edge device in accordance with the selected alternative (step 334). The controller flying roaming edge device sends the adjusted navigation path to the selected worker land roaming edge device and the adjusted corresponding navigation path to the other worker land roaming edge device (step 336). Thereafter, the process returns to step 314 where the controller flying roaming edge device determines whether another worker land roaming edge device exists in the set of worker land roaming edge devices.

Returning again to step 318, if the controller flying roaming edge device determines that the selected worker land roaming edge device is not currently en route to a way point of the set of way points in the navigation path, no output of step 318, then the controller flying roaming edge device determines that the selected worker land roaming edge device has reached the way point and is ready to perform an assigned task corresponding to that particular way point (step 338). The controller flying roaming edge device retrieves details corresponding to an asset associated with the assigned task that corresponds to that particular way point from an asset management system (step 340). The controller flying roaming edge device performs an assessment of an ability of the selected worker land roaming edge device to perform the assigned task corresponding to that particular way point based on the details corresponding to the asset associated with the assigned task (step 342). The controller flying roaming edge device makes a determination as to whether the selected worker land roaming edge device can perform the assigned task corresponding to that particular way point based on the assessment of the ability of the selected worker land roaming edge device (step 344). If the controller flying roaming edge device determines that the selected worker land roaming edge device can perform the assigned task corresponding to that particular way point based on the assessment of the ability of the selected worker land roaming edge device, yes output of step 344, then the process returns to step 314 where the controller flying roaming edge device determines whether another worker land roaming edge device exists in the set of worker land roaming edge devices. If the controller flying roaming edge device determines that the selected worker land roaming edge device cannot perform the assigned task corresponding to that particular way point based on the assessment of the ability of the selected worker land roaming edge device, no output of step 344, then the process returns to step 324 where the controller flying roaming edge device determines a set of alternatives to perform the assigned task.

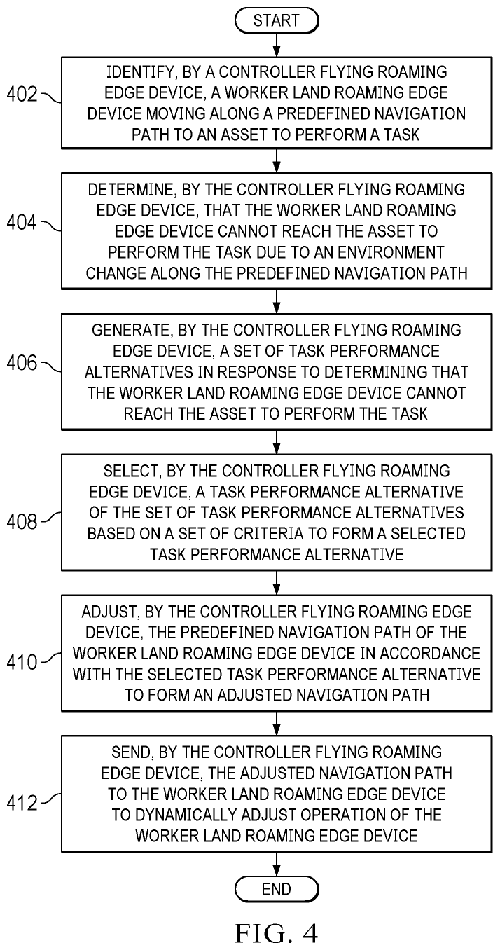

With reference now to FIG. 4, a flowchart illustrating a process for adjusting a navigation path of a worker edge device is shown in accordance with an illustrative embodiment. The process shown in FIG. 4 may be implemented in a controller edge device, such as, for example, controller edge device 107 in FIG. 1 or controller flying roaming edge device 202 in FIG. 2. For example, the process shown in FIG. 4 may be implemented in worker edge device management code 200 in FIG. 1 or worker edge device management code 214 in FIG. 2.

The process begins when the controller flying roaming edge device identifies a worker land roaming edge device moving along a predefined navigation path to an asset to perform a task (step 402). Subsequently, the controller flying roaming edge device determines that the worker land roaming edge device cannot reach the asset to perform the task due to an environment change along the predefined navigation path (step 404).

The controller flying roaming edge device generates a set of task performance alternatives in response to determining that the worker land roaming edge device cannot reach the asset to perform the task (step 406). The controller flying roaming edge device selects a task performance alternative of the set of task performance alternatives based on a set of criteria to form a selected task performance alternative (step 408).

The controller flying roaming edge device adjusts the predefined navigation path of the worker land roaming edge device in accordance with the selected task performance alternative to form an adjusted navigation path (step 410). The controller flying roaming edge device sends the adjusted navigation path to the worker land roaming edge device to dynamically adjust operation of the worker land roaming edge device (step 412).

Thus, illustrative embodiments of the present invention provide a computer-implemented method, computer system, and computer program product for performing dynamic operational adjustment of mobile worker edge devices by a mobile controller edge device. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for adjusting a navigation path of a worker land roaming edge device, the computer-implemented method comprising:
identifying, by a controller flying roaming edge device, the worker land roaming edge device moving along a navigation path to an asset to perform a task;
determining, by the controller flying roaming edge device, that the worker land roaming edge device cannot reach the asset to perform the task due to an environment change along the navigation path;
generating, by the controller flying roaming edge device, a set of task performance alternatives in response to determining that the worker land roaming edge device cannot reach the asset to perform the task;
selecting, by the controller flying roaming edge device, a task performance alternative of the set of task performance alternatives based on a set of criteria to form a selected task performance alternative;
adjusting, by the controller flying roaming edge device, the navigation path of the worker land roaming edge device in accordance with the selected task performance alternative to form an adjusted navigation path; and
sending, by the controller flying roaming edge device, the adjusted navigation path to the worker land roaming edge device to dynamically adjust operation of the worker land roaming edge device.

2. The computer-implemented method of claim 1 further comprising:
performing, by the controller flying roaming edge device, monitoring of a defined area where a set of worker land roaming edge devices is operating; and
detecting, by the controller flying roaming edge device, the set of worker land roaming edge devices operating in the defined area using a set of analytical models.

3. The computer-implemented method of claim 2 further comprising:
selecting, by the controller flying roaming edge device, the worker land roaming edge device from the set of worker land roaming edge devices operating in the defined area to form a selected worker land roaming edge device;
obtaining, by the controller flying roaming edge device, an identifier and a navigation path status from the selected worker land roaming edge device; and
retrieving, by the controller flying roaming edge device, the navigation path corresponding to the selected worker land roaming edge device from a navigation path repository using the identifier of the selected worker land roaming edge device, the navigation path including a set way points, each way point of the set of way points corresponding to an assigned task of a set of assigned tasks of the selected worker land roaming edge device.

4. The computer-implemented method of claim 3 further comprising:
determining, by the controller flying roaming edge device, whether the selected worker land roaming edge device is currently en route to a way point of the set of way points in the navigation path;
responsive to the controller flying roaming edge device determining that the selected worker land roaming edge device is not currently en route to a way point of the set of way points in the navigation path, determining, by the controller flying roaming edge device, that the selected worker land roaming edge device has reached the way point and is ready to perform an assigned task corresponding to that particular way point;
retrieving, by the controller flying roaming edge device, details corresponding to an asset associated with the assigned task that corresponds to that particular way point from an asset management system;
performing, by the controller flying roaming edge device, an assessment of an ability of the selected worker land roaming edge device to perform the assigned task corresponding to that particular way point based on the details corresponding to the asset associated with the assigned task;
determining, by the controller flying roaming edge device, whether the selected worker land roaming edge device can perform the assigned task corresponding to that particular way point based on the assessment of the ability of the selected worker land roaming edge device; and
responsive to the controller flying roaming edge device determining that the selected worker land roaming edge device cannot perform the assigned task corresponding to that particular way point based on the assessment of the ability of the selected worker land roaming edge device, determining, by the controller flying roaming edge device, the set of task performance alternatives to perform the assigned task.

5. The computer-implemented method of claim 4 further comprising:
responsive to the controller flying roaming edge device determining that the selected worker land roaming edge device is currently en route to a way point of the set of way points in the navigation path, performing, by the controller flying roaming edge device, an assessment of an environment along the navigation path of the selected worker land roaming edge device in the defined area to identify any unexpected change in the environment that will prevent the selected worker land roaming edge device from reaching that particular way point;
determining, by the controller flying roaming edge device, whether the selected worker land roaming edge device can reach that particular way point based on the assessment of the environment along the navigation path of the selected worker land roaming edge device; and
responsive to the controller flying roaming edge device determining that the selected worker land roaming edge device cannot reach that particular way point based on the assessment of the environment along the navigation path of the selected worker land roaming edge device, determining by the controller flying roaming edge device, the set of task performance alternatives to perform the assigned task.

6. The computer-implemented method of claim 5 further comprising:
selecting, by the controller flying roaming edge device, an alternative of the set of task performance alternatives to perform the assigned task based on the set of criteria to form the selected task performance alternative; and
determining, by the controller flying roaming edge device, whether the selected task performance alternative involves another worker land roaming edge device of the set of worker land roaming edge devices.

7. The computer-implemented method of claim 6 further comprising:
responsive to the controller flying roaming edge device determining that the selected task performance alternative does not involve another worker land roaming edge device of the set of worker land roaming edge devices, adjusting, by the controller flying roaming edge device, the navigation path of the selected worker land roaming edge device in accordance with the selected task performance alternative to form an adjusted navigation path; and
sending, by the controller flying roaming edge device, the adjusted navigation path to the selected worker land roaming edge device.

8. The computer-implemented method of claim 6 further comprising:
responsive to the controller flying roaming edge device determining that the selected task performance alternative does involve another worker land roaming edge device of the set of worker land roaming edge devices, adjusting, by the controller flying roaming edge device, the navigation path of the selected worker land roaming edge device and adjusting a corresponding navigation path of the other worker land roaming edge device in accordance with the selected task performance alternative; and
sending, by the controller flying roaming edge device, the adjusted navigation path to the selected worker land roaming edge device and the adjusted corresponding navigation path to the other worker land roaming edge device.

9. A controller flying roaming edge device for adjusting a navigation path of a worker land roaming edge device, the controller flying roaming edge device comprising:
a communication fabric;
a storage device connected to the communication fabric, wherein the storage device stores program instructions; and
a processor connected to the communication fabric, wherein the processor executes the program instructions to:
identify the worker land roaming edge device moving along a navigation path to an asset to perform a task;
determine that the worker land roaming edge device cannot reach the asset to perform the task due to an environment change along the navigation path;
generate a set of task performance alternatives in response to determining that the worker land roaming edge device cannot reach the asset to perform the task;
select a task performance alternative of the set of task performance alternatives based on a set of criteria to form a selected task performance alternative;
adjust the navigation path of the worker land roaming edge device in accordance with the selected task performance alternative to form an adjusted navigation path; and
send the adjusted navigation path to the worker land roaming edge device to dynamically adjust operation of the worker land roaming edge device.

10. The controller flying roaming edge device of claim 9, wherein the processor further executes the program instructions to:
perform monitoring of a defined area where a set of worker land roaming edge devices is operating; and
detect the set of worker land roaming edge devices operating in the defined area using a set of analytical models.

11. The controller flying roaming edge device of claim 10, wherein the processor further executes the program instructions to:
select the worker land roaming edge device from the set of worker land roaming edge devices operating in the defined area to form a selected worker land roaming edge device;
obtain an identifier and a navigation path status from the selected worker land roaming edge device; and
retrieve the navigation path corresponding to the selected worker land roaming edge device from a navigation path repository using the identifier of the selected worker land roaming edge device, the navigation path including a set way points, each way point of the set of way points corresponding to an assigned task of a set of assigned tasks of the selected worker land roaming edge device.

12. The controller flying roaming edge device of claim 11, wherein the processor further executes the program instructions to:
determine whether the selected worker land roaming edge device is currently en route to a way point of the set of way points in the navigation path;
determine that the selected worker land roaming edge device has reached the way point and is ready to perform an assigned task corresponding to that particular way point in response to determining that the selected worker land roaming edge device is not currently en route to a way point of the set of way points in the navigation path;
retrieve details corresponding to an asset associated with the assigned task that corresponds to that particular way point from an asset management system;
perform an assessment of an ability of the selected worker land roaming edge device to perform the assigned task corresponding to that particular way point based on the details corresponding to the asset associated with the assigned task;
determine whether the selected worker land roaming edge device can perform the assigned task corresponding to that particular way point based on the assessment of the ability of the selected worker land roaming edge device; and
determine the set of task performance alternatives to perform the assigned task in response to determining that the selected worker land roaming edge device cannot perform the assigned task corresponding to that particular way point based on the assessment of the ability of the selected worker land roaming edge device.

13. A computer program product for adjusting a navigation path of a worker land roaming edge device, the computer program product comprising a computer-readable storage medium having program instructions embodied therewith, the program instructions executable by a controller flying roaming edge device to cause the controller flying roaming edge device to perform a method of:
identifying, by the controller flying roaming edge device, the worker land roaming edge device moving along a navigation path to an asset to perform a task;
determining, by the controller flying roaming edge device, that the worker land roaming edge device cannot reach the asset to perform the task due to an environment change along the navigation path;
generating, by the controller flying roaming edge device, a set of task performance alternatives in response to determining that the worker land roaming edge device cannot reach the asset to perform the task;
selecting, by the controller flying roaming edge device, a task performance alternative of the set of task performance alternatives based on a set of criteria to form a selected task performance alternative;
adjusting, by the controller flying roaming edge device, the navigation path of the worker land roaming edge device in accordance with the selected task performance alternative to form an adjusted navigation path; and
sending, by the controller flying roaming edge device, the adjusted navigation path to the worker land roaming edge device to dynamically adjust operation of the worker land roaming edge device.

14. The computer program product of claim 13 further comprising:
performing, by the controller flying roaming edge device, monitoring of a defined area where a set of worker land roaming edge devices is operating; and
detecting, by the controller flying roaming edge device, the set of worker land roaming edge devices operating in the defined area using a set of analytical models.

15. The computer program product of claim 14 further comprising:
selecting, by the controller flying roaming edge device, the worker land roaming edge device from the set of worker land roaming edge devices operating in the defined area to form a selected worker land roaming edge device;
obtaining, by the controller flying roaming edge device, an identifier and a navigation path status from the selected worker land roaming edge device; and
retrieving, by the controller flying roaming edge device, the navigation path corresponding to the selected worker land roaming edge device from a navigation path repository using the identifier of the selected worker land roaming edge device, the navigation path including a set way points, each way point of the set of way points corresponding to an assigned task of a set of assigned tasks of the selected worker land roaming edge device.

16. The computer program product of claim 15 further comprising:
determining, by the controller flying roaming edge device, whether the selected worker land roaming edge device is currently en route to a way point of the set of way points in the navigation path;
responsive to the controller flying roaming edge device determining that the selected worker land roaming edge device is not currently en route to a way point of the set of way points in the navigation path, determining, by the controller flying roaming edge device, that the selected worker land roaming edge device has reached the way point and is ready to perform an assigned task corresponding to that particular way point;
retrieving, by the controller flying roaming edge device, details corresponding to an asset associated with the assigned task that corresponds to that particular way point from an asset management system;
performing, by the controller flying roaming edge device, an assessment of an ability of the selected worker land roaming edge device to perform the assigned task corresponding to that particular way point based on the details corresponding to the asset associated with the assigned task;
determining, by the controller flying roaming edge device, whether the selected worker land roaming edge device can perform the assigned task corresponding to that particular way point based on the assessment of the ability of the selected worker land roaming edge device; and
responsive to the controller flying roaming edge device determining that the selected worker land roaming edge device cannot perform the assigned task corresponding to that particular way point based on the assessment of the ability of the selected worker land roaming edge device, determining, by the controller flying roaming edge device, the set of task performance alternatives to perform the assigned task.

17. The computer program product of claim 16 further comprising:
responsive to the controller flying roaming edge device determining that the selected worker land roaming edge device is currently en route to a way point of the set of way points in the navigation path, performing, by the controller flying roaming edge device, an assessment of an environment along the navigation path of the selected worker land roaming edge device in the defined area to identify any unexpected change in the environment that will prevent the selected worker land roaming edge device from reaching that particular way point;
determining, by the controller flying roaming edge device, whether the selected worker land roaming edge device can reach that particular way point based on the assessment of the environment along the navigation path of the selected worker land roaming edge device; and
responsive to the controller flying roaming edge device determining that the selected worker land roaming edge device cannot reach that particular way point based on the assessment of the environment along the navigation path of the selected worker land roaming edge device, determining by the controller flying roaming edge device, the set of task performance alternatives to perform the assigned task.

18. The computer program product of claim 17 further comprising:
selecting, by the controller flying roaming edge device, an alternative of the set of task performance alternatives to perform the assigned task based on the set of criteria to form the selected task performance alternative; and
determining, by the controller flying roaming edge device, whether the selected task performance alternative involves another worker land roaming edge device of the set of worker land roaming edge devices.

19. The computer program product of claim 18 further comprising:
responsive to the controller flying roaming edge device determining that the selected task performance alternative does not involve another worker land roaming edge device of the set of worker land roaming edge devices, adjusting, by the controller flying roaming edge device, the navigation path of the selected worker land roaming edge device in accordance with the selected task performance alternative to form an adjusted navigation path; and
sending, by the controller flying roaming edge device, the adjusted navigation path to the selected worker land roaming edge device.

20. The computer program product of claim 18 further comprising:
responsive to the controller flying roaming edge device determining that the selected task performance alternative does involve another worker land roaming edge device of the set of worker land roaming edge devices, adjusting, by the controller flying roaming edge device, the navigation path of the selected worker land roaming edge device and adjusting a corresponding navigation path of the other worker land roaming edge device in accordance with the selected task performance alternative; and
sending, by the controller flying roaming edge device, the adjusted navigation path to the selected worker land roaming edge device and the adjusted corresponding navigation path to the other worker land roaming edge device.
